(19) United States
(12) Patent Application Publication
(10) Pub. No.: US 2008/0133419 A1
(43) Pub. Date: Jun. 5, 2008

(54) SECURE FINANCIAL TRANSACTION SYSTEM AND METHOD

(76) Inventors: Brian Wormington, San Francisco, CA (US); William R. Lear, Fairport, NY (US)

Correspondence Address: GREENBERG TRAURIG, LLP, MET LIFE BUILDING, 200 PARK AVENUE, NEW YORK, NY, 10166, US

(21) Appl. No.: 11/567,041

(22) Filed: Dec. 5, 2006

(51) Int. Cl. H04L 9/00

(52) U.S. Cl. 705/64; 705/65

(57) ABSTRACT

A method for performing secure financial transactions using a secure computing device enables consumers to make purchase on or offline without transmitting sensitive financial data to sellers. A buyer can pay a seller by associating a financial account with a secure computing device and transmitting a digitally signed payment record containing the agreed upon purchase price to a seller. The digitally signed payment record does not contain the buyer's sensitive financial data.

### BACKGROUND

Early financial transactions took the form of simple barter—direct trading of goods or services deemed to be of equivalent value by the two participants in the transaction. As the economic marketplace became wider spread and more diverse, currency provided a method for the indirect trade of goods and services.

The increased flexibility of a cash based economy came at the expense of an increased risk of theft. Physical possession of currency is all that is required for a buyer to complete a transaction, so cash is an extremely attractive target for thieves.

Credit cards (and subsequently debit cards) were developed to increase the convenience and security of financial transactions by reducing the need for participants to carry and exchange large amounts of bearer-negotiable cash.

Credit cards were initially conceived and implemented as a two factor authentication system. Buyers needed to both possess something (the credit card) and know something (how to sign the proper signature) in order to perform a transaction. To reduce the risk of fraud due to signature forgery, the vendors first checked lists of lost, stolen and revoked cards prior to accepting a credit card for a purchase.

In order to simplify credit card transactions, the two factor authentication degraded over time into a single factor authentication. A buyer needed only to possess the card. Signatures and buyer ID were rarely verified. Cards were still checked against lists of lost, stolen or revoked cards, but instances of credit card fraud increased. To avoid losing buyers due to fear of fraud, credit institutions indemnified the cardholders and merchants against loss and absorbed the cost of fraudulent transactions.

With the growth of catalog mail order, telephone and internet sales, credit card transactions have further degraded to use an even weaker single factor authentication. There is no longer a requirement for the buyer to be in possession of the physical card. A buyer need know only the information on the card (account number, expiration date and possibly name and security code) in order to complete a purchase. Anyone coming into possession of this information (such an unscrupulous vendor) can impersonate the rightful owner and perform a fraudulent credit transaction.

Debit cards have introduced the additional protection of a Personal Identification Number (PIN), but this feature is only useable at Point of Sale terminals. It cannot be used for phone or eCommerce transactions.

This weakening of the credit card authentication process has definitely made credit transactions easier, but at a cost of a significant increase in fraudulent transactions. Credit institutions have continued to indemnify cardholders against loss from fraud. The growing cost of this indemnification is of course passed to the legitimate cardholders and merchants in the form of higher interest rates and transaction fees.

Rapidly escalating occurrences of security breaches and private data theft have raised the consumer awareness level to a point where even the promise of full indemnification against loss is not sufficient to guarantee the ongoing success of the current credit and debit card transaction model.

Numerous digital transaction processing systems have been created to handle conventional credit/debit card. Most have involved three key elements:
Encrypted transmission of sensitive data
Real time authentication from servers representing the credit/debit card issuing institution.
Use of digital certificates to provide a level of authentication for online merchants.

As an alternative solution, smart cards were developed and promoted as a secure replacement for cash. Smart cards have had some success in Europe where the communications infrastructure was not initially robust enough to support real time credit/debit card validation.

Unfortunately, users found they must guard their smart cards as if they were cash. Losing a stored value smart card was equivalent to losing cash. Furthermore, due to the increased authentication security offered by the smart card, credit institutions reduced their indemnification of users against loss. Thus, there was little incentive for users to embrace smart cards.

Accordingly, there is a need in the art for enabling consumers to make purchases, on or offline without transmitting sensitive data. There is also a need in the art for a secure replacement for cash that consumers can use to make purchases without transmitting sensitive data.

### SUMMARY

The disclosed embodiments of a Secure Financial Transaction (SFT) System and method for performing same are designed to restore security and consumer faith in credit and debit transactions while providing the ease of use consumers have come to demand.

Preferred embodiments of the SFT System restore the secure two factor authentication of both parties (buyer and seller) face-to-face and remote transactions. Even though no information directly identifying credit card numbers or other sensitive data is exchanged, each party can be assured of the identity of the other participant. The use of one-time credentials eliminates the threat of fraud through the use of information obtained by eavesdropping on legitimate transactions. The secure storage and processing capabilities of the Secure Computing Device (SCD) allow the execution of secure offline transactions with no immediate communication channel to a centralized authentication entity such as the issuing credit card institution. The purchase transaction protocols guarantee non-repudiation on the part of both the buyer and seller. Neither side can subsequently deny participation in a completed transaction.

### BRIEF DESCRIPTION OF THE DRAWINGS

These and other features, aspects and advantages of the present invention will become better understood with regard to the following description, appended claims, and accompanying drawings where:

FIG. 1 is a diagram representing major components of a secure financial transaction system according to one embodiment of the invention;

FIG. 2 is an embodiment of the secure computing device of the secure financial transaction system of FIG. 1;

FIG. 3 shows a high level layered architecture of a secure financial transaction system that can be used in conjunction with some embodiments of the present invention;

FIG. 4 is a block diagram showing the main software elements residing on one embodiment of the secure financial transaction interface of the secure financial transaction system of FIG. 1;

FIG. 5 is a block diagram showing main software and data elements residing on one embodiment of the transfer agent management server of the secure financial transaction system of FIG. 1;

FIG. 6 is a block diagram representing primary functional elements in one embodiment of a portable secure computing device of the secure financial transaction system of FIG. 1;

FIG. 7 is a diagram showing the main software elements of one embodiment of the secure computing device of FIG. 1;

FIGS. 8a-8c are block diagrams showing some potential options for connecting the portable secure computing device of FIG. 6 to a consumer electronic device; and

FIG. 9 is a block diagram showing an alternate centralized Local Area Network connected secure computing device configuration option.

### DESCRIPTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

The disclosed embodiments of a Secure Financial Transaction (SFT) System and method for performing same are designed to restore security and consumer faith in credit and debit transactions while providing the ease of use consumers have come to demand.

Preferred embodiments of the SFT System restore the secure two factor authentication of both parties (buyer and seller) face-to-face and remote transactions. Even though no information directly identifying credit card numbers or other sensitive data is exchanged, each party can be assured of the identity of the other participant. The use of one-time credentials eliminates the threat of fraud through the use of information obtained by eavesdropping on legitimate transactions. The secure storage and processing capabilities of the Secure Computing Device (SCD) allow the execution of secure offline transactions with no immediate communication channel to a centralized authentication entity such as the issuing credit card institution. The purchase transaction protocols guarantee non-repudiation on the part of both the buyer and seller. Neither side can subsequently deny participation in a completed transaction.

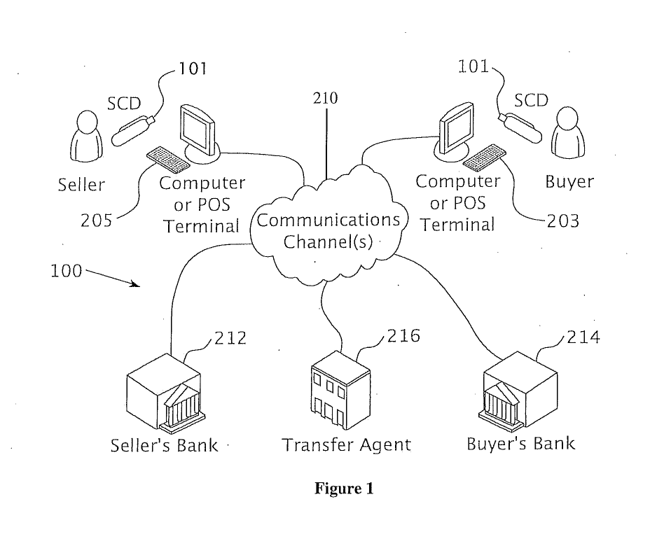

FIG. 1 shows an embodiment of the SFT system. The embodiment uses a combination of hardware, software, and network servers to form a simple yet robust digital SFT processing infrastructure. This infrastructure is capable of completely replacing all current credit and debit transactions while repairing the inherent security reductions and compromises associated with the traditional card based transactions.

Some system components shown in FIG. 1 include the buyer and seller SCDs 101; consumer electronic device, computer or POS terminal (collectively referred to herein as “SFT interface”) 203; seller computer 205; communications channel 210; sellers bank 212; buyer's bank 214; and transfer agent 216, such as a credit card company or other SCD administrator. It should be noted that the seller's bank 212, buyer's bank 214 and transfer agent 216 need not be separate entities. One or more entities can satisfy all three roles. The SFT interface 203 can be of any type including a computer, cell phone, PDA, gaming device, TV, etc. All of these examples of system components are not necessary in embodiments of the invention but are merely an example of components that could be used to implement an embodiment of the invention.

Although this preferred system and method of performing SFT's is disclosed other embodiments can be used.

A unique element of the preferred embodiment of the SFT system 100 shown in FIG. 1 is the secure computing device (“SCD”) 101. In this embodiment, the SCD provides the authentication and authorization capabilities required by each participant in a SFT.

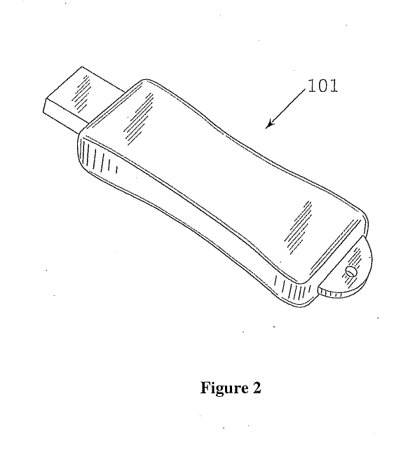

The initial implementation of the SCD (FIG. 2) is as a small USB module, similar in size and form to a USB flash memory module. In fact, the SCD can include flash memory and function as a standard memory module.

Each SCD 101 comprises a small but general purpose computing module, special purpose cryptographic processing circuitry, volatile and non-volatile memory, and a real-time timer/clock encapsulated in a highly tamper resistant package.

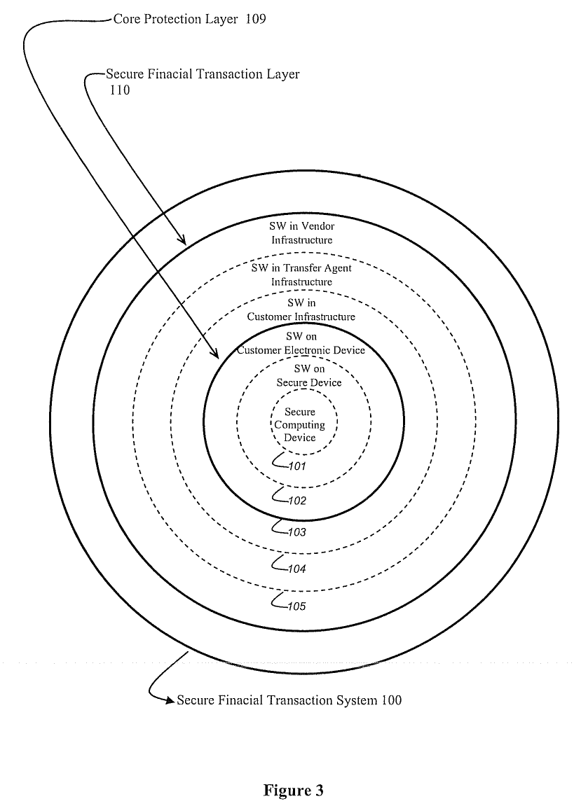

Referring now to FIG. 3, the SCD 101, software 102 on the SCD and software 103 on a SFT interface 203 form a core protection layer 109 of the system 100. Software 104 in buyer infrastructure 221, software 105 in SFT infrastructure 205 and software 106 in vendor infrastructure 223 form a SFT layer 110.

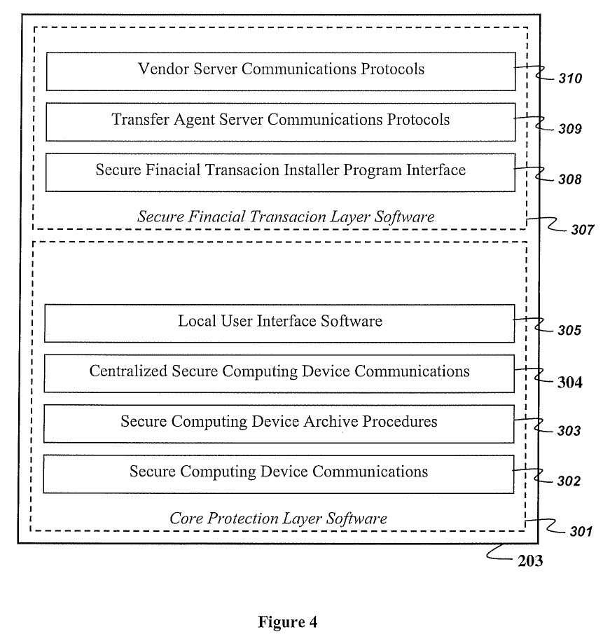

FIG. 4 shows software elements that may reside on a SFT interface 207. The elements include core protection layer software 301 and SFT layer software 307. The core protection layer software can include SCD communications software 302, SCD archive procedures software 303, centralized SCD communications software 304, local user interface software 305 and protected application critical code fragment (“CCF”) proxy software 306. The SFT layer software 307 can include vendor server communications protocols software 310.

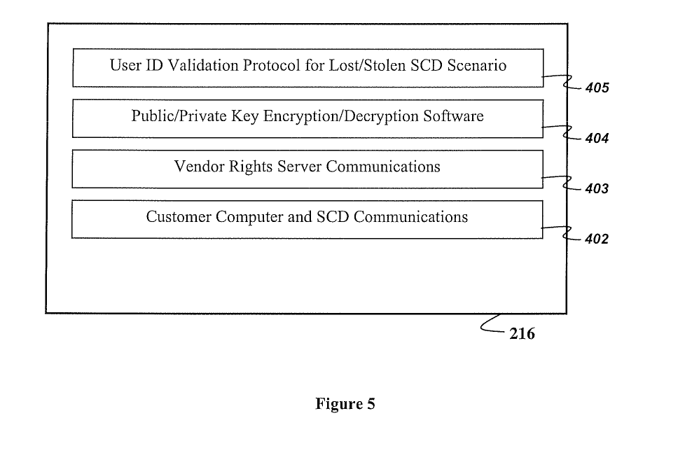

FIG. 5 shows software elements that may reside on the transfer agent server 216. These elements include SFT interface and SCD communications software 402, vendor server communications software 403, public/private key encryption/decryption software 404 and user ID validation protocol for lost/stolen SCD scenario software 405.

### Secure Computing Device

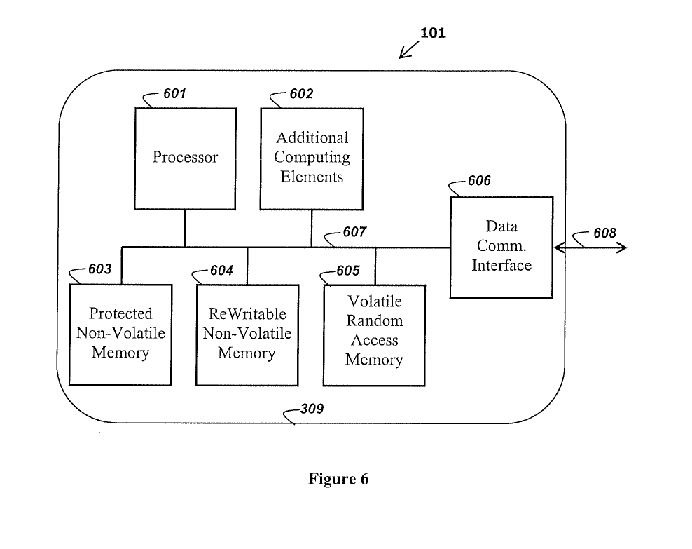

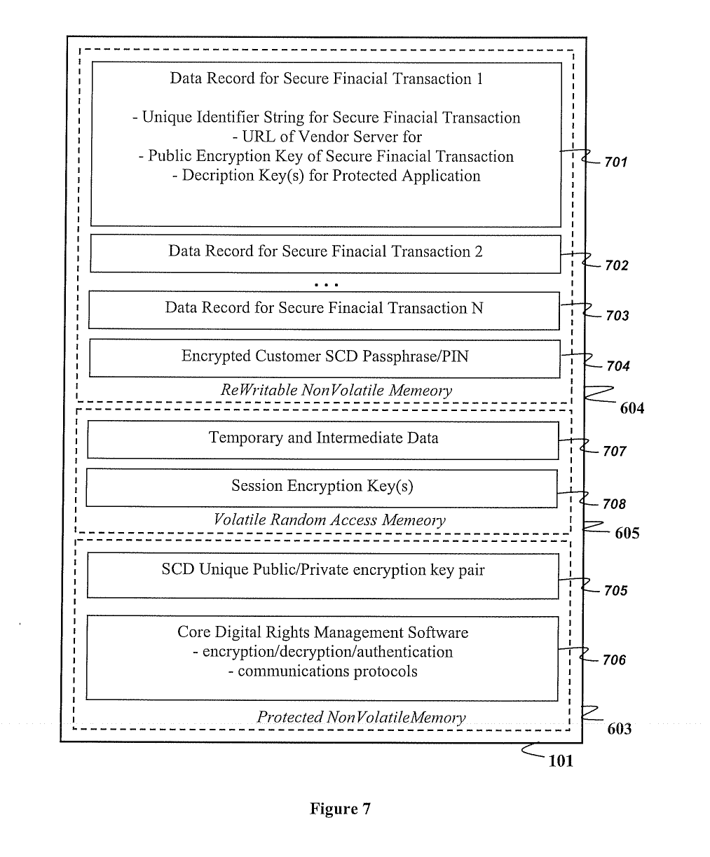

FIG. 6 shows the primary functional elements and FIG. 7 shows the software elements in the SCD 101. The SCD 101 preferably contains:

Protected Non-Volatile Memory (PNVM) 603 for storing the program instructions of the SCD resident core SFT software 706, and for storing a Public/Private Encryption key pair 705 unique to each particular SCD 101. The contents of the PNVM 603 preferably are written prior to delivery to a buyer, and cannot be read or altered by any buyer initiated actions.

Re-writable Non-Volatile Memory (RWNVM) 604 for storing the data records 701, 702, 703 for each SFT registered to the particular SCD 101. The RWNVM 604 also preferably stores an encrypted buyer SCD pass phrase or Pin 704. The contents of the RWNVM 604 are altered during the various usage scenarios, but preferably cannot be directly read or altered by the buyer.

Volatile Random Access Memory (RAM) 605 for storing intermediate results and temporary data 707 and session encryption key(s) 708 required for proper operation of the software program instructions contained in the PNVM 603 and RWNVM 604. The contents of the RAM preferably cannot be directly read or altered by the buyer. The contents of the RAM are lost when power is disconnected from the SCD 101.

One or more general purpose processing elements 601 for executing software program instructions contained in the PNVM 603 and RWNVM 604.

Zero or more Optional additional computing elements 602 for optimized execution of real-time clock and timer functions, computationally complex encryption, decryption, and authentication algorithms.

One or more Data Communications Interfaces 606 and external interconnections 608 providing a method for reliably providing power to the SCD 101 and for transferring digital data between the SCD and the SFT interface 203.

One or more internal data communications paths 607 providing a method for reliably transferring digital data between the modules within the SCD 101. The data on these paths cannot be directly viewed or altered by the buyer.

Tamper-resistant packaging 309 which prevents anyone from gaining useable information regarding the data and software contained in the SCD 101. This includes, but is not limited to protection against physical or electrical access to the internal SCD elements without destroying the data and software contained therein.

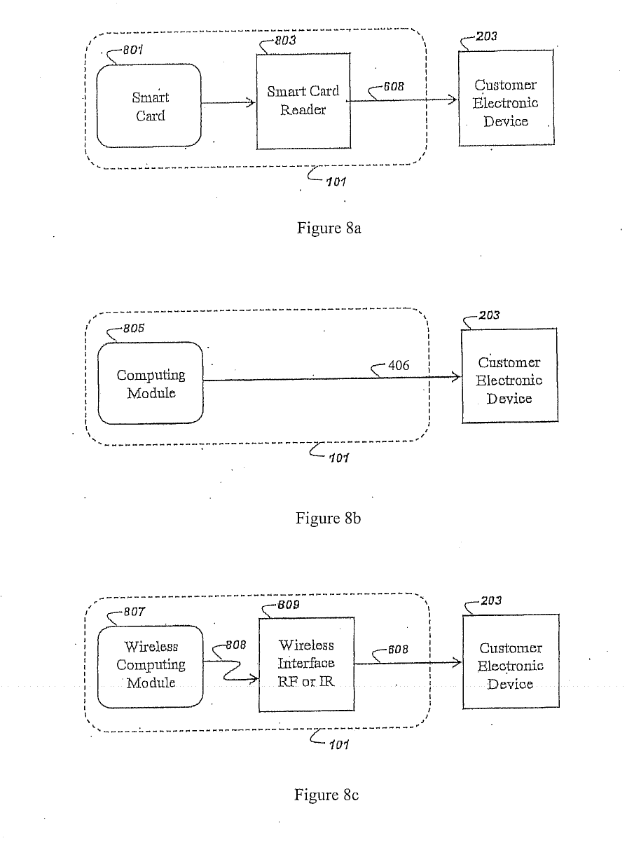

FIGS. 8a-8c show three possible alternative configurations for connecting the SCD 101 to the SFT interface 203.

FIG. 8a shows a conventional smart card 801 which is physically mated with a smart card reader 803. The reader 803 is in communication with the SFT interface 203 via an external connection 608 supported by the particular device. Example interfaces include but are not limited to PCMCIA card slot, RS232 Serial port, Universal Serial Bus (USB) connection, FireWire Connection, PCI bus connection, and Network interface. The reader 803 could be external to or built into the SFT interface 203.

FIG. 8b shows a similar configuration in which the reader 803 is eliminated because a computing module 805 directly connects to a communications interface 406 supported by the SFT interface 203. Example interfaces include but are not limited to PCMCIA card slot, RS232 Serial port, USB, FireWire and Network interface. The secure computing module 805 would typically be external to and removable from the SFT interface 203. The secure computing module 805 can be built into the device 203, but digital rights assigned to that SCD 101b are then inherently linked to that specific SFT interface.

FIG. 8c shows a configuration in which the wireless computing module 807 communicates with the SFT interface 203 via a wireless transmission 808 to a wireless interface 809 connected to the SFT interface via a supported communications interface 608. The wireless transmission 808 could use radio frequency (RF), InfraRed (IR), or other wireless methods. The wireless interface 809 could be external to or built in to the SFT interface 203.

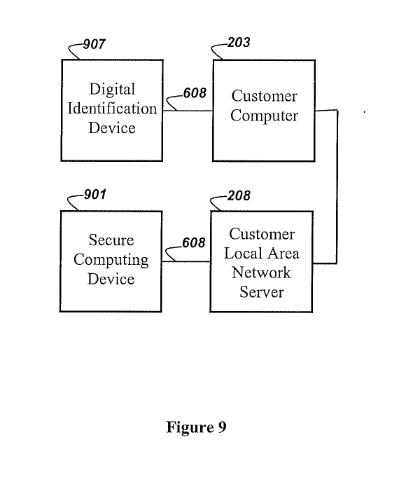

FIG. 9 shows an alternative system configuration in which the buyer Local Area Network server 208 is in communication with a master SCD 901. This configuration offers some advantages in certain multiple SFT interfaces environments.

In this option, a master SCD 901 is in communication with a buyer LAN server 208 which is in turn in communication with one or more SFT interfaces 203. The master SCD 901 can use any of the alternative configurations shown in FIG. 8a, 8b and 8c to connect to the buyer LAN sever 208. In this case, buyer identification is separated from digital rights authorization.

Individual buyers identify themselves at a particular SFT interface 203 by connecting a digital identification device (DID) 907 to the SFT interface. The DID 907 may be an RF ID tag or dongle, or could be another SCD 101. The DID 907 is not used to directly determine software usage rights. Rather, the DID 907 is used to identify the user to the master SCD 901 via software running on the buyer LAN server 208.

### Protection Against Loss or Theft of Secure Computing Device

A preferred embodiment includes five specific loss prevention methods.

First, as described in Usage Scenario A, infra, the buyer may configure the SCD 101 to require the entry of a PIN or Pass phrase each time the SCD is connected to a SFT interface 203. The SCD 101 is not useable by anyone who does not know the PIN/Pass phrase. The SCD 101 is programmed to deactivate itself if an incorrect PIN/Pass phrase is entered too many times. Once deactivated, the SCD 101 is not useable until the buyer reactivates the SCD using the method described in Usage Scenario H, infra. This reactivation procedure requires independent proof of the Buyer's identity. This proof includes:

Buyer access to and response from the email account specified by the buyer during the initial registration of the SCD 101; and/or

Proper responses to a sequence of questions answered by the buyer during the initial registration of the SCD 101.

Second, the buyer can report an SCD 101 lost or stolen and request it to be deactivated by accessing the transfer agent 216 via the wide area network 210. Similar to the reactivation procedure, this deactivation procedure requires independent proof of the buyer's identity. When the data record for a specific SCD 101 in the digital rights database 218 has been marked for deactivation, the SCD will be directed to deactivate itself the next time it is used in any scenario requiring communications with the digital rights server via the WAN 210.

Third, each SCD 101 is programmed to automatically deactivate itself if a predetermined time period elapses without the buyer performing a usage scenario requiring connection to the WAN 210. If, during this time period, the buyer does not perform any of the scenarios requiring communications with the Transfer agent 216, the buyer must explicitly perform the “Phone Home” procedure described in Usage Scenario F, infra. This procedure assures that a lost or stolen SCD 101 will be deactivated in a reasonable timeframe. If an SCD 101 is allowed to deactivate itself due to lack of communications with the Transfer agent 216, the legitimate buyer can reactivate it by performing the reactivation procedure described in Usage Scenario H, infra.

Fourth, the buyer can transfer all account information previously assigned to a deactivated SCD 101 to a new SCD by using the procedure described in Usage Scenario I, infra. This allows a legitimately registered buyer to resume use of all authorized software even if the original SCD 101 is never recovered.

Fifth, as an alternative or adjunct to the personal identification query/response system, the buyer can designate an SCD 101 as a master identification SCD of one or more other SCDs. This master identification SCD may be presented by the buyer and used in lieu of the personal identification query/response process in Scenarios H, I and J, infra, for any of the linked SCDs. Deactivation of a lost master identification SCD would require the use of the personal identification query/response system or another master identification SCD linked to the master identification SCD to be deactivated.

### Usage Scenarios

The capabilities of the preferred embodiment of the invention are best shown through the description of a number of core use case scenarios.

Note: These use cases do not document the low-level secure communications handshake protocol used for communications between two SCDs. When the term “Send” is used in these use cases, it means “Send and receive acknowledgement of receipt of”. This level of acknowledgement indicates only uncorrupted deliver and receipt of the message, not agreement or commitment to the content of the message.

The following sections describe usage scenarios, in which various capabilities of the system are achieved.

Prior to entering into enabled SFT transactions, each participant must acquire and register an SCD.

### Scenario A. Buyer Acquires and Registers a New Secure Computing Device

1. Buyer purchases or otherwise receives a new SCD 101 containing only the core SFT software 706 and a Public/Private Encryption Key pair 705 unique to that specific device.

2. Buyer connects the new SCD 101 to a SFT interface 203 having wide area network (WAN) access 209.

3. Buyer installs the SFT interface resident SFT software components 301,307 provided with the new SCD 101.

4. Buyer uses the Transfer agent communications protocols 309 on the SFT interface 203 to establish a secure communications link via the WAN 210 to the Transfer agent 216.

5. This may be accomplished using established protocols such as Secure Sockets Layer (SSL). This can be a high or low bandwidth network connection such as a dialup connection.

6. The software running on the Transfer agent 216 receives the public encryption key from the SCD 101, and sends its own public encryption key to the Transfer agent communications protocols 309 on the SFT interface 203.

7. The Transfer agent software queries the transfer agent 216 for a record containing the new SCD public encryption key.

8. If a database record is not found, the SCD 101 is not authorized. The Transfer agent software sends a message to the buyer stating that the SCD 101 is not valid, and this scenario ends.

9. If a database record for the public key is found, the Transfer agent software queries the record to determine if the SCD 101 has previously been registered.

10. If the SCD 101 has been previously registered, it cannot be re-registered. The Transfer agent software sends a message to the buyer stating that the SCD 101 is already registered, and this scenario ends.

11. If the SCD 101 has not been previously registered, the Transfer agent software requests the buyer to select a personal identification number (PIN) or pass phrase to be entered by the buyer each time the SCD is connected to a SFT interface 203.

12. The Transfer agent communications protocol 309 encrypts the PIN or pass phrase with the SCD public encryption key, and stores the encrypted PIN in the SCD 101. From

13. this point on, the buyer must enter the PIN each time the SCD 101 is connected to a SFT interface 203.

14. The Transfer agent software requests an identifier string for the SCD 101. This identifier string will be used by the buyer to differentiate this SCD from others that may be currently or later registered to the buyer.

15. The Transfer agent software next requests personal identification information from the buyer to aid in the recovery of SFT information if the SCD 101 is ever lost or stolen. This information includes:

16. Valid buyer email address

17. Buyer responses to a series of predefined or buyer defined security questions such as “What is your mother's middle name?” and “What is your favorite city?”

18. The buyer need not honor these requests, but if the information is not provided the buyer will be unable to report his SCD 101 as lost or stolen, and will be unable to recreate any digital rights information contained in the lost or stolen SCD.

19. If the buyer chooses to provide the requested information, the SFT layer software 307 on the SFT interface 203 collects the email address and question answers from the buyer.

20. The email address is encrypted using the Transfer agent public encryption key and is sent to the Transfer agent 216 via the secure network connection.

21. The buyer responses to the security questions are not sent to the Transfer agent 216. Rather, the SFT layer software 307 on the SFT interface 203 uses a message digest algorithm such as MD5 to create an irreversible message digest of the set of answers.

22. The message digest is then encrypted with the Transfer agent public encryption key and is sent to the Transfer agent 216.

23. The Transfer agent software creates a record, which is sent to the transfer agent 216 and associates the message digest with the public encryption key for the new SCD 101. This message digest will be used as a unique user identifier key in the event the SCD 101 is ever lost or stolen.

24. The Transfer agent software updates the database record for the SCD public encryption key, indicating that this SCD 101 has been registered.

25. This scenario ends.

### Scenario B. Buyer Initializes an SCD

In this scenario, a buyer links an SCD to one or more financial accounts.

1. Buyer acquires and registers an SCD using procedure described in scenario A.

2. Buyer establishes a secure authenticated communication link between the Buyer's SCD and the Buyer's financial institution. Link can be via Web/SSL, personal visit, SFT enabled ATM, etc. or any other secure authenticated communication link known in the art.

3. Buyer presents financial institution with proof of account access rights. This authentication is institution specific and beyond the scope of this specification. There are several which are well-known in the art.

4. Buyer directs financial institution to link the SCD to the account.

5. Financial institution records the SCD public key and associates it with the account records for future authentication.

6. Financial institution transfers approved off-line transaction limit record to Buyer's SCD, depending on account type and institution policies. For example, the financial institution can reserve the off-line limit amount from the full amount available from the involved Buyer's account.

7. Buyer terminates secure link. SCD can be removed. Or, Buyer can optionally repeat steps 2 through 6 for additional accounts at the same or different institution.

An offline transaction is a purchase (or refund) transaction effected between a buyer and a seller without any real-time communication channel between either party and any financial institution. Using the SFT system, a buyer and seller can securely perform a purchase transaction up to the remaining off-line transaction limit available on the Buyer's SCD. A refund transaction is potentially a special case—If the original transaction has not yet been posted to the financial institution, the refund can be effected completely off-line by negating the original purchase records in the Buyer's and Seller's SCD's. If, on the other hand, the original transaction has already been posted, a refund transaction is simply a purchase transaction with the roles of Buyer and Seller reversed. This implies that in this case a refund can only be performed if there is sufficient credit available in the Buyer's offline limit record.

### Scenario C. Seller Initializes an SCD

In this scenario, a seller links an SCD to one or more financial accounts.

1. Seller acquires and registers an SCD using procedure described in Scenario A.

2. Seller establishes a secure authenticated communication link between the Seller's SCD and the Seller's financial institution.

3. Seller presents financial institution with proof of account access rights. This authentication is institution specific and beyond the scope of this specification. There are several which are well-known in the art.

4. Seller directs financial institution to link the SCD to the account.

5. Financial institution records the SCD public key and associates it with the account records for future authentication.

6. Optionally the financial institution transfers record of current Seller Rating to Seller's SCD. The Seller Rating provides an indication of the Seller's past transaction record. Successful transactions raise the rating, disputed transactions lower the rating.

7. Financial institution transfers approved off-line transaction limit record to Seller's SCD, depending on account type and institution policies. For example, the financial institution can reserve the off-line limit amount from the full amount available from the involved Seller's account. The Seller's offline transaction limit record determines the maximum value refund transaction the seller is authorized to perform offline.

8. Seller terminates secure link. SCD can be removed. Or, Seller can optionally repeat steps 2 through 6 for additional accounts at the same or different institution. The Buyer's SCD preferably is a small portable unit. A merchant, on the other hand, may need a larger capacity SCD to hold a large number of transactions. A merchant would not want to lose an SCD containing a large number of unposted transactions, so a commercial unit may require physical security—lockdown cable, fire retardant, etc. In addition, a commercial SCD might be integrated into a point-of-sale terminal to allow direct connection to a buyer's SCD.

### Scenario D. Purchase Transaction

In this scenario, a Buyer uses the system to perform a purchase transaction.

1. Buyer selects a seller, and determines what goods or services are to be purchased, and indicates to seller the intent to purchase. This uses existing methods: physical shopping, website/shopping cart, etc. This step could also include price negotiation, delivery time, etc.

2. Buyer establishes a secure authenticated communication link between the Buyer's SCD and the Seller's SCD. Link can be via Web/SSL, SFT enabled Point of Sale Terminal, etc., accordingly, the link can be on or offline.

3. Optionally Seller's SCD sends digitally signed current Seller Rating record to the Buyer's SCD.

4. If Buyer finds Seller Rating unacceptable, the Buyer can abort the transaction.

5. Seller sends digitally signed “Offer” record to Buyer's SCD. The Offer record preferably includes a timestamp and expiration time.

6. If the Buyer finds the offer unacceptable, the Buyer can abort the transaction.

7. Buyer selects one or more accounts associated with the Buyer's SCD for use in paying for the purchase.

8. If more than one account is selected, Buyer specifies allocation of purchase amount among the selected accounts.

9. Buyer accepts the offer by directing the Buyer's SCD to append a payment record to the offer record, digitally sign the composite record and return it to the Seller's SCD.

10. If the Offer expiration time has passed, Seller can choose to abort the transaction.

11. Seller acknowledges the acceptance by sending a digitally signed Receipt record to the Buyer's SCD. At this point, the purchase transaction is complete. Both Buyer's and Seller's SCDs contain copies of the doubly signed accepted offer record defining the terms of the transaction. The three-way handshake (Offer, Accept, and Receipt) ensures that both sides of the transaction are synchronized.

12. Buyer and/or Seller can terminate the secure link.

### Scenario E. Aborted Purchase Transaction

When a Purchase transaction is initiated as described in scenario D. but is not allowed to proceed through the conclusion of step 11 (Seller successfully sending the signed “Receipt” record) due to communications loss or disconnection by either the buyer or seller, the purchase transaction is considered to be aborted. The involved Buyer's SCD and the Seller's SCD each deletes all records associated with the aborted transaction.

Scenario F. Buyer performs required periodic “Phone-home” SCD Validation

1. Buyer connects an SCD 101 and enters the associated PIN/Pass phrase by following the steps 1 though 6 of Scenario F, supra.

2. Buyer runs the local user interface software 305 of the SFT interface resident core protection layer software 301 and directs the software to perform the validation procedure.

3. The SFT interface resident core protection layer software 301 obtains the public encryption key from the connected SCD 101 and sends this key to the Transfer agent 216 for validation.

The Transfer agent 216 queries the data record for the SCD public key stored by the transfer agent 216. If the data record shows no problem with the specified SCD 101, this scenario continues at step 7.

5. If the data record shows the SCD 101 has been marked for deactivation (via Usage Scenario G, infra), the Transfer agent 216 encrypts a deactivation message using the SCD public encryption key and sends it to the SFT interface resident software, which in turn sends the deactivation message to the SCD.

6. Once deactivated, the SCD 101 cannot be used until reactivated using the procedure described in Scenario H, infra. This scenario ends.

7. If there is no problem registered with the SCD 101, the Transfer agent 216 encrypts a validation message using the SCD public encryption key, and sends it to the SFT interface resident software which in turn sends the validation message to the SCD.

8. Upon receipt and authentication of the validation message, the SCD 101 resets its internal deactivation timer.

9. This scenario ends.

Scenario G. Buyer Deactivates a Lost or Stolen Secure Computing Device

1. If the buyer did not provide personal identification information in steps 13 through 15 of Scenario A, supra, this deactivation sequence cannot be performed, in which case this scenario ends.

2. Otherwise, the buyer uses a SFT interface 203 with WAN 2 10 access to connect to the Transfer agent 216.

3. Buyer directs the Transfer agent software to perform the deactivation procedure.

4. The Transfer agent software sends a message containing a unique identifier character sequence to the email address contained in the data record for the SCD 101 by the transfer agent 216.

5. The Transfer agent 216 notifies the buyer that the email has been sent, and instructs the buyer to retrieve the message, and reply following the directions contained in the email.

6. If the buyer does not properly reply to the sent email within a specified time, the deactivation sequence is canceled, and this scenario ends.

7. If the buyer properly retrieves and replies to the sent email, the Transfer agent software requests the SFT interface resident software to prompt the buyer for answers to the security questions originally answered by the buyer in steps 13 thru 15 of Scenario A, supra.

8. The SFT software on the SFT interface 203 collects the answers, and uses a message digest algorithm such as MD5 to create an irreversible digest of the set of answers. This message digest is then encrypted with the Transfer agent public encryption key, and sent to the Transfer agent 216.

9. If the message digest does not match the digest created during the original registration of the SCD 101, the deactivation sequence is canceled, and this scenario ends.

10. Otherwise, the Transfer agent 216 uses the message digest string as a secondary access key to the transfer agent 216, and locates the data records for all associated SCDs 101.

11. The transfer agent 216 presents the buyer with a list containing the identifier strings assigned to each associated SCD 101 when initially registered.

12. The buyer selects the SCD('s) 101 to be deactivated.

13. The data record for the associated SCD('s) 101 is (are) marked for deactivation.

14. The buyer is notified of the successful operation.

15. This Scenario ends.

### Scenario H. Buyer Reactivates an SCD Previously Deactivated Due to Lost/Stolen Report or Excessive Number of Invalid PIN/Pass Phrase Entries.

1. If the buyer did not provide personal identification information in steps 13 through 15 of Scenario A, supra, this reactivation sequence cannot be performed. This Scenario ends.

2. Otherwise, the buyer uses a SFT interface 203 with WAN 210 access to connect to the Transfer agent 216.

3. Buyer directs the Transfer agent software to perform the reactivation procedure.

4. The Transfer agent software sends a message containing a unique identifier character sequence to the email address contained in the data record for the SCD 101 at the transfer agent 216.

5. The Transfer agent notifies the buyer that the email has been sent, and instructs the buyer to retrieve the message, and reply following the directions contained in the email.

6. If the buyer does not properly reply to the sent email within a specified time, the reactivation sequence is canceled, and this scenario ends.

7. If the buyer properly retrieves and replies to the sent email, the Transfer agent software requests the SFT interface resident software to prompt the buyer for answers to the security questions originally answered by the buyer in steps 13 thru 15 of Scenario A, supra.

8. The SFT software on the SFT interface 203 collects the answers, and uses a message digest algorithm such as MD5 to create an irreversible digest of the set of answers. This message digest is then encrypted with the Transfer agent public encryption key, and sent to the Transfer agent 216.

9. If the message digest does not match the digest created during the original registration of the SCD 101, the reactivation sequence is canceled, and this scenario ends.

10. Otherwise, the Transfer agent 216 uses the message digest string as a secondary access key to the transfer agent 216, and locates the data records for all SCDs 101 associated with that e-mail address currently marked as deactivated.

11. The Transfer agent 216 presents the buyer with a list containing the identifier strings assigned to each located SCD 101 when initially registered.

12. The user selects the SCD('s) 101 to reactivate.

13. The data record for the associated SCD('s) is 101 (are) marked for reactivation.

14. The buyer is notified of the successful operation.

15. The specified SCD 101 will be reactivated the next time the SCD is connected to a SFT interface 203 for use in any of the scenarios requiring communication with the Transfer agent 216.

16. This scenario ends

Scenario 1. Buyer Replaces a Lost or Stolen SCD and Reconstructs Usage Rights Previously Assigned to that SCD

1. If the buyer did not provide personal identification information in steps 13 through 15 of Scenario A, supra, this sequence cannot be performed. This replacement scenario ends.

2. Otherwise, the buyer uses a SFT interface 203 with WAN 210 access to connect to the Transfer agent 216.

3. Buyer directs the Transfer agent software to perform the replacement procedure.

4. The Transfer agent software sends a message containing a unique identifier character sequence to the email address contained in the data record for the SCD 101 at the transfer agent 216.

5. The Transfer agent 216 notifies the buyer that the email has been sent, and instructs the buyer to retrieve the message, and reply following the directions contained in the email.

6. If the buyer does not properly reply to the sent email within a specified time, the replacement sequence is canceled, and this scenario ends.

7. If the buyer properly retrieves and replies to the sent email, the Transfer agent software requests the SFT interface resident software to prompt the buyer for answers to the security questions originally answered by the buyer in steps 13 thru 15 of Scenario A, supra.

8. The SFT software on the SFT interface 203 collects the answers, and uses a message digest algorithm such as MD5 to create an irreversible digest of the set of answers. This message digest is then encrypted with the Transfer agent public encryption key, and sent to the Transfer agent 216.

9. If the message digest does not match the digest created during the original registration of the SCD 101, the replacement sequence is canceled, and this scenario ends.

10. Otherwise, the Transfer agent 216 uses the message digest string as a secondary access key to the digital rights database 218, and locates the data records for all SCDs 101 associated with that e-mail address that have been marked as deactivated.

11. The server software presents the buyer with a list containing the identifier strings assigned to each SCD 101 when initially registered.

12. The buyer selects the SCD('s) 101 to be replaced.

13. For each SCD 101 to be replaced, server software prompts the buyer to connect the replacement SCD to the SFT interface 203. Each replacement SCD 101 must have been previously registered using the procedure described in usage Scenario A, supra.

14. The user connects the replacement SCD 101 to the SFT interface 203, and enters the associated PIN/Pass phrase.

15. The Transfer agent software receives the public encryption key from the replacement SCD 101, and verifies it has been properly registered.

16. If the replacement SCD 101 has not been properly registered, the buyer is notified, and this scenario ends.

17. If the replacement SCD 101 is properly registered, the Transfer agent 216 creates a link between the data record for the replacement SCD and the data record for the deactivated SCD.

18. The deactivated SCD 101 can no longer be reactivated.

19. From this point forward, vendor server software can query the Transfer agent 216 and receive confirmation that the new SCD 101 has replaced the deactivated SCD, and is eligible to be assigned all usage rights previously assigned to the deactivated SCD.

20. The buyer is notified of the successful operation.

### Transaction Processing by Buyer's and Seller's Financial Institutions

Transaction processing by the Buyer's and Seller's banks is outside the scope of this specification.

A transaction is processed by the Buyer's financial institution when a transaction record, a.k.a. buyer financial institution purchase record is received from the Buyer, Seller, or other authorized party. If multiple copies of the same transaction record are received, only the first copy is processed. Subsequent duplicate transaction records are acknowledged but not processed.

For the purpose of better understanding the SFT system, the basic financial institution processing operations can be viewed as:

1. Buyer's financial institution receives and validates the authenticity of a transaction record.

2. Funds specified by the transaction record are debited from the buyer's account (and released from the reserve amount)

3. Debited funds are transferred to the seller's financial institution to be credited to the seller's account specified in the transaction record, a.k.a. seller financial institution purchase record.

### Design Strategies

Throughout the high level design of the system, certain strategies should be followed

Preferably, designs are inherently modular, distributed and scalable

Preferably, inter-module communications use standard interfaces, protocols and communication channels whenever possible

Preferable, all cryptographic elements are implemented using publicly reviewed and proven algorithms.

Preferably, where possible each module should perform validity checks on all aspects of neighboring modules—input, protocol, and timing validation, code signature authentication, etc.

Preferably, every transaction and data exchange is analyzed to assess the risk and impact of being compromised.

Although the present invention has been described in considerable detail with reference to certain preferred versions thereof, other versions are possible. For example, the SCD can be in the form of a swipeable card. Therefore, the spirit and scope of the appended claims should not be limited to the description of the preferred versions contained herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means or step for” clause as specified in 35 U.S.C. §112.

1. A method for performing a secure financial transaction, comprising:
enabling a buyer to associate at least one buyer financial account with a buyer secure computing device; and
enabling the buyer to transmit a payment record to a seller, the payment record containing an agreed purchase price and information identifying the buyer secure computing device;
and wherein the buyer secure computing device comprises:
a protected non-volatile memory storing a public/private encryption key pair;
re-writeable non-volatile memory for storing the payment record;
volatile random access memory for storing session encryption keys;
processing elements for executing software; and
a communication interface for transferring data to and from the secure computing device.

2. The method of claim 1 wherein the payment record is digitally signed.

3. The method of claim 1 further comprising:
enabling a seller to associate at least one seller financial account to a seller secure computing device; and
enabling the payment record to be appended to the seller secure computing device.

4. The method of claim 3 further comprising enabling the seller to transmit a receipt record to the buyer secure computing device.

5. The method of claim 3 further comprising enabling the seller to send an offer record to the buyer secure computing device.

6. The method of claim 1 further comprising enabling the seller to choose with which of the at lease one buyer financial account to associate with the payment record.

7. The method of claim 6 wherein the seller associates multiple buyer financial accounts with the payment record.

8. The method of claim 1 wherein the payment record comprises multiple records.

9. The method of claim 1 further comprising:
enabling the at least one buyer financial institution to transmit a transaction limit record to the buyer secure computing device.

10. The method of claim 3 wherein the payment record is transmitted to the seller secure computing device directly from the buyer secure computing device.

11. The method of claim 1 wherein the payment record is transmitted to the seller offline.

12. The method of claim 3 further comprising enabling the seller to transmit a payment record to the a seller financial institution.

13. The method of claim 1 further comprising enabling the buyer to transmit a payment record to the buyer financial institution.

14. (canceled)

15. A system for performing a secure financial transaction comprising:
a buyer secure computing device
a seller secure computing device; and
a communication channel for enabling the buyer secure computing device to communicate with the seller secure computing device; and wherein the buyer secure computing device comprises:
a protected non-volatile memory storing a public/private encryption key pair;
re-writeable non-volatile memory for storing the payment record;
volatile random access memory for storing session encryption keys;
processing elements for executing software; and
a communication interface for transferring data to and from the secure computing device.

16. The method of claim I wherein the public/private encryption key pair are stored in the protected non-volatile memory prior to delivery of the secure computing device to the buyer.

17. The secure computing device of claim 15 wherein the public/private encryption key pair are stored in the protected non-volatile memory prior to delivery of the secure computing device to the buyer.

18. The secure computing device of claim 15 wherein the secure computing device is in the form of a USB module.

19. The secure computing device of claim 15 wherein the secure computing device is integral with a consumer electronic device.

20. The secure computing device of claim 15 wherein the secure computing device is removable from a consumer electronic device.
